(19) United States
(12) Patent Application Publication
(10) Pub. No.: US 2014/0207697 A1
(43) Pub. Date: Jul. 24, 2014

(54) Enterprise Family Tree

(71) Applicant: FMR LLC, Boston, MA (US)

(72) Inventors: Heidi Katherine Hess von Ludewig, Cary, NC (US); Martin Charles Heermance, Arlington, MA (US)

(73) Assignee: FMR LLC, Boston, MA (US)

(21) Appl. No.: 13/858,301

(22) Filed: Apr. 8, 2013

Related U.S. Application Data
(60) Provisional application No. 61/754,104, filed on Jan. 18, 2013.

(51) Int. Cl. G06Q 10/10

(52) U.S. Cl. CPC G06Q 10/105
USPC 705/320

(57) ABSTRACT

An enterprise-based tree structure system is provided that includes a plurality of servers for receiving and processing a request for retrieval of enterprise-based information of an employee. The enterprise-based information includes information detailing the employee's contacts and affiliation within an enterprise. The enterprise-based information is stored in one or more of the servers. A framework aids the servers to process and retrieve the enterprise-based information stored in the one or more servers needed to service the request. The framework processes the enterprise-based information allowing a user the ability to understand and identify the employee's contact and affiliation with the enterprise.

### PRIORITY INFORMATION

This application claims priority from provisional application Ser. No. 61/754,104 filed Jan. 18, 2013, which is incorporated herein by reference in its entirety.

### BACKGROUND OF THE INVENTION

The invention is related to the field of hierarchical database management, in particular an enterprise-based family tree for managing employee relationship within an enterprise.

To create a hierarchical tree structure requires organizing the information, and displaying it in the form easily representable to a user. This requires searching multiple databases through a network and scanning the database for relevant information, reviewing the information according to a set of algorithms for relationships to other individuals entered into the local database and assessing the probability that the newly identified individual is related to the original individual. Moreover, the information is provided along with the probability assessment to the user for acceptance or rejection and updating the database upon acceptance of the user.

There are many known systems that accomplish these aforementioned steps of collecting information and storing the information as data records that represent tree elements (e.g., nodes and relationships). The elements, however, are not conclusively linked together and the information therein is not deemed correct, but instead the information is used to infer relationships and attributes when the likeliness exceeds a threshold. As a result, new information may strengthen, diminish, or not affect an existing inference of a relationship or information about a person. Conversely, many previously-known systems collect data using a tree structure. New information is added only by linking off of existing trees or starting a new tree. The tree structure is the essence of the data gathering process. If a user adds new information by creating a seemingly incorrect relationship, the situation is corrected only by dissolving the relationship. Once the relationship is dissolved by a subsequent user, the previous user's interpretation of information that leads to the perceived existence of the relationship is gone.

### SUMMARY OF THE INVENTION

According to one aspect of the invention, there is provided an enterprise-based tree structure system. The enterprise-based tree structure system includes a plurality of servers for receiving and processing a request for retrieval of enterprise-based information of an employee. The enterprise-based information includes information detailing the employee's contacts and affiliation within an enterprise. The enterprise-based information is stored in one or more of the servers. A framework aids the servers to process and retrieve the enterprise-based information stored in the one or more servers needed to service the request. The framework processes the enterprise-based information allowing a user the ability to understand and identify the employee's contact and affiliation with the enterprise.

According to another aspect of the invention, there is provided there is provided a method of managing an enterprise-based tree structure system. The method includes receiving and processing a request for retrieval of enterprise-based information of an employee from a plurality of servers. The enterprise-based information includes information detailing the employee's contacts and affiliation within an enterprise. The enterprise-based information is stored in one or more of the servers. Moreover, the method includes processing and retrieving the enterprise-based information stored in the one or more servers needed to service the request using a framework. The framework processes the enterprise-based information allowing a user the ability to understand and identify the employee's contact and affiliation with the enterprise.

### BRIEF DESCRIPTION OF THE DRAWINGS

FIG. 1 is a schematic diagram illustrating an employee relationship record used in accordance with the invention;

FIG. 2 is a schematic diagram illustrating the system network architecture used in accordance with the invention;

FIGS. 3A-3B are schematic diagrams that illustrate the process flow in fulfilling a command request by a user in accordance with the invention; and

FIG. 4 is a schematic diagram illustrating process flow for performing compound searches.

### DETAILED DESCRIPTION OF THE INVENTION

The invention is an enterprise family tree application tool that stores and displays role, management, and team information of employees within a company, or within multiple companies, over time. The invention allows one to develop an employee relationship record in one or more databases detailing the employee's contacts and affiliation within the corporation. This way even when an employee leaves the corporation, that employee relationship record can be saved for later retrieval or analysis for possible future work.

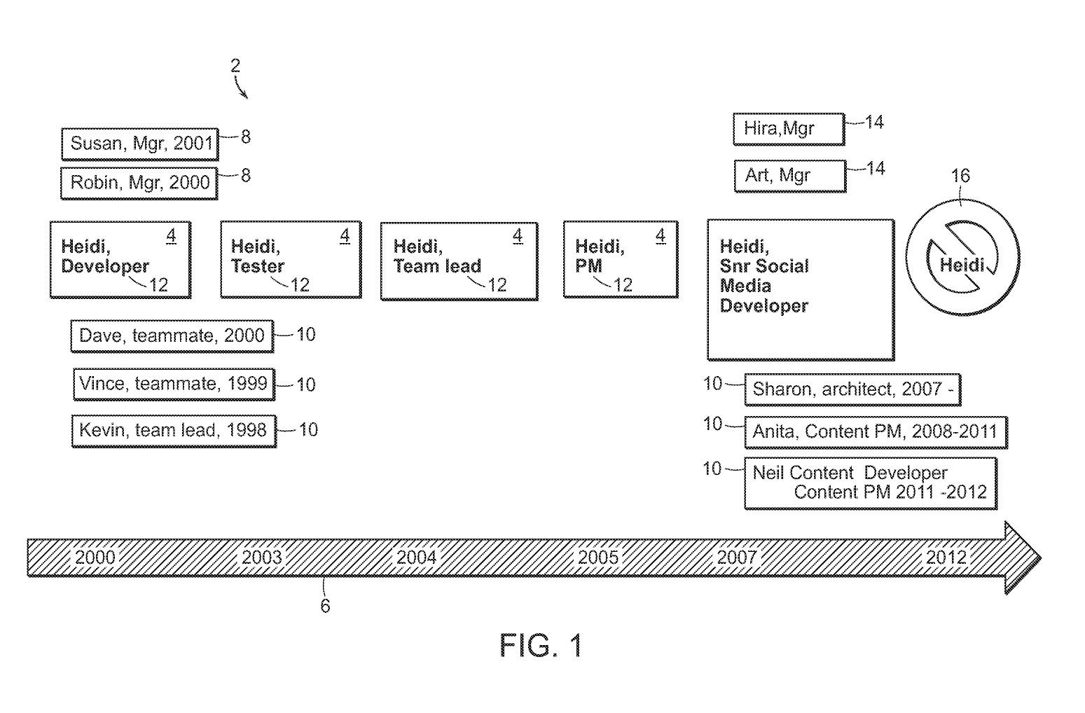

For one to see an employee relationship record, the user inputs the employee's name into a database for retrieval. When the employee record is found, the last known (current) team tree structure 2 is provided, as shown in FIG. 1. If the user wants to view the employee's prior teams and roles 4, then the user selects a time by entering text or using a slider bar 6 to move through the employee's record. The tree structure 2 can show the employee's management chain 8 and 14, their colleague connections 10, and role and responsibilities 12. Moreover, the invention allows one to see how these changes occur over time using the slide bar 6. For instance, if one looks up Heidi in December 2000, one can see in that period she was a developer working in a team with Dave, Vince, and Kevin. Her supervisors are Susan and Robin during this period. When one chooses a different time period, January 2012, one can see Heidi was promoted to Snr Social Media Developer and works with Sharon, Anita, and Neil in a team. Also, Heidi must report to Hira and Art as her managers. Note the invention provides the flexibility in displaying this information to the user but the important aspect here is classifying an employee's relationship within an enterprise.

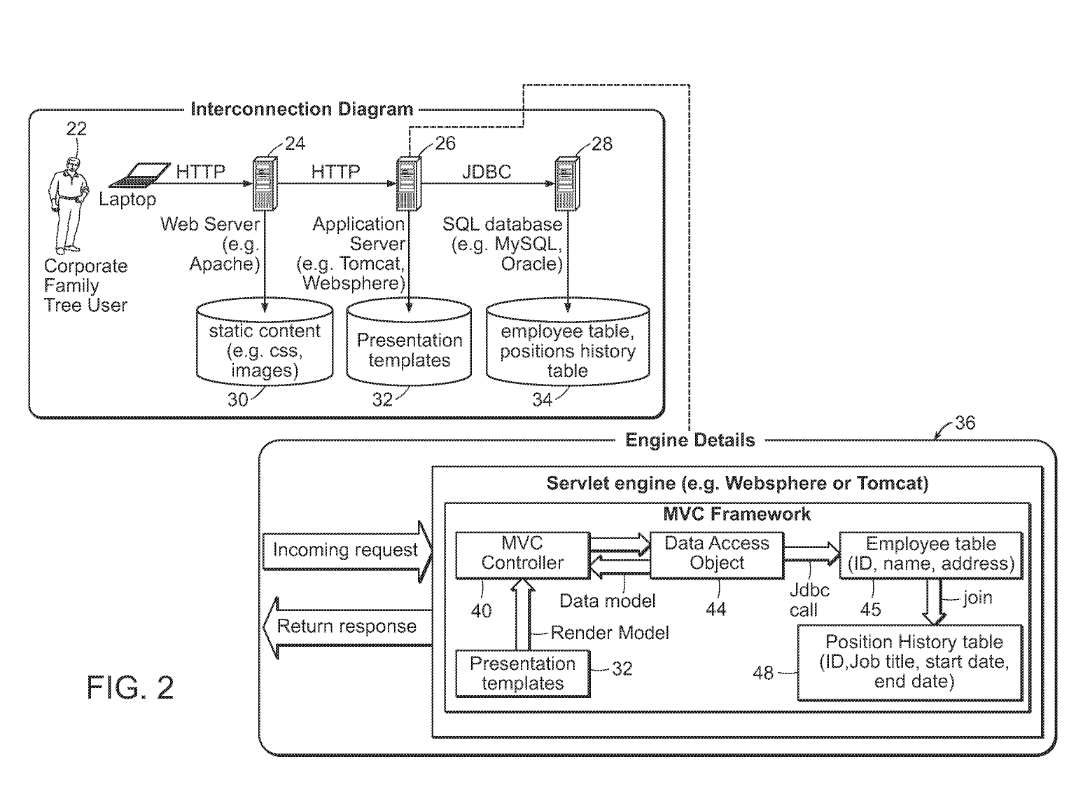

FIG. 2 shows the system network architecture 20 used in accordance with the invention. In particular, FIG. 2 shows a user 22 inputting a search request for an employee using a web browser. The web browser can be executed either on a computer system 36 such as a lap top, a portable device, or a desktop. The web browser communicates the search request to a web server 24. The web server 24 is used primarily to deliver web pages on the request of clients using the Hypertext Transfer Protocol (HTTP). This means delivery of HTML documents and any additional content 30 that may be included by a document, such as images, style sheets and scripts for database calculations.

Web servers are not always used for serving the World Wide Web. They can also be found embedded in devices such as printers, routers, webcams and serving only a local network. The web server 24 can then be used as a part of a system for monitoring and/or administering the device in question. This usually means that no additional software has to be installed on the client computer system 36, since only a web browser is required, which now is included with most operating systems in the market today.

Application server 24 can either be a software framework that provides a generalized approach to creating an application-server implementation, without regard to what the application functions are, or the server portion of a specific implementation instance. In either case, the server's function is dedicated to the efficient execution of procedures (programs, routines, scripts) for supporting its applied applications. Most application server frameworks contain a comprehensive service layer model using presentation templates 32. An application server 26 can act as a set of components accessible to the software developer through an application programming interface (API) defined by the platform itself. For web-based applications, these components are usually performed in the same running environment as its web server(s), and their main job is to support the construction of dynamic pages. However, many application servers target much more than just web page generation: they implement services like clustering, failover, and load-balancing, so developers can focus on implementing the business logic.

The architecture 20 includes a SQL server 28 that is a relational database management system (RDBMS) designed for the enterprise environment. The SQL server 28 runs on T-SQL (Transact-SQL), a set of programming extensions that add several features to standard SQL, including transaction control, exception and error handling, row processing, and declared variables. The database files 34 are usually stored on the SQL server 28 machine and a database needs to be set up to hold the physical files for each database application. This task is often performed by the database administrator so that a new empty database is provided for the programmer to configure.

When a user sends a search request to search for an employee relationship record, the commands are passed thru the various servers 24, 26 until the SQL server 28 executes a selective number of SQL statements to retrieve data from the databases 34. Note the SQL server 28 relies on the application server 26 to issue it the SQL statements for execution. The application server 26 includes a Model-view-controller (MVC) framework 36 that implements SQL statements needed to perform the search request as well as package the results from the SQL server for viewing by the user. The application server 26 issues a JDBC call to the SQL server 28 that includes the SQL statements for execution.

The MVC framework 36 is a web application framework that implements the model-view-controller (MVC) pattern. The MVC 40 is a software architecture pattern that separates the representation of information from the user's interaction with it. The data access object 44 includes application data, business rules, logic, and functions. Many times the data access object issues database calls, such as Java Database Connectivity (JDBC) calls, to get access to data associated with the database access object 44. These JDBC calls are issued to the SQL server to execute commands to retrieve data 44, 46 from databases 34. The presentation template 32 includes the output representation of data, such as a chart or a diagram. Multiple views of the same data are possible, such as a pie chart for management and a tabular view for accountants. The MVC 40 mediates input and converting it to commands for the data access object or view using the presentation template 32. The central ideas behind MVC are code reusability and separation of concerns.

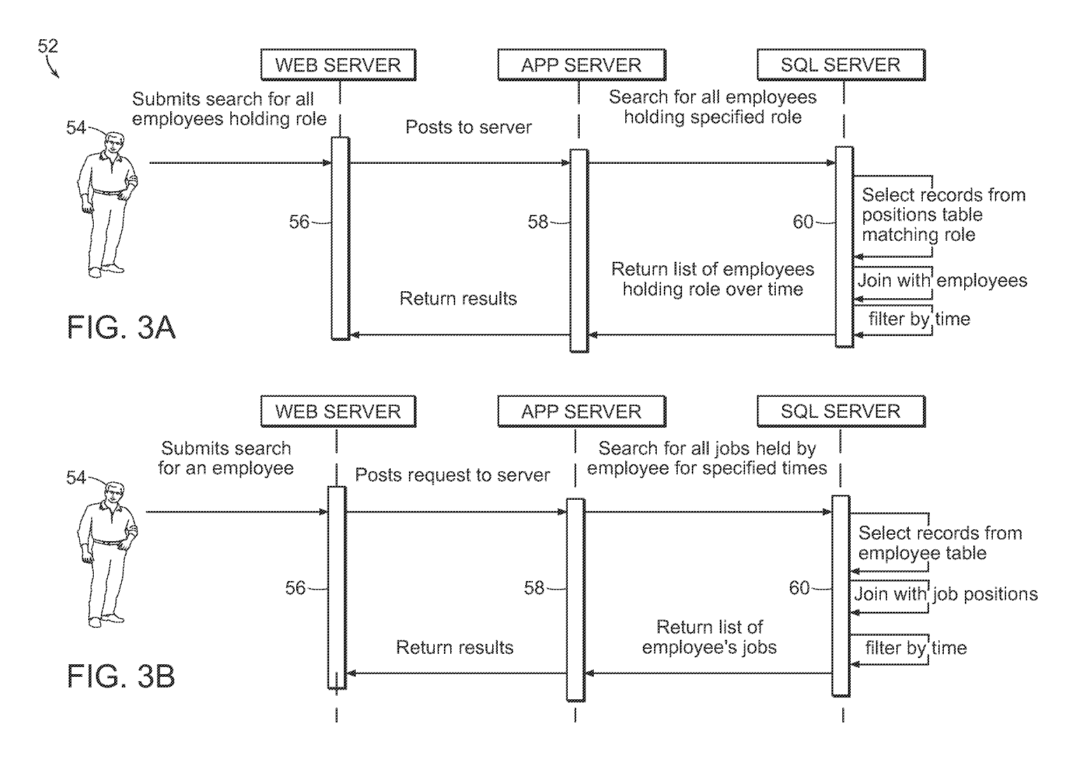

FIGS. 3A-3B are schematic diagrams that illustrate the process flow in fulfilling a command request by a user in accordance with the invention. A user 54 issues a command for searching the relationship criteria of an employee thru a web browser. In this case, the web browser issues a command to a web server for processing. The invention is an application that stores and displays role, manager, and team information of employees within a company, or within multiple companies, over time. To see an employee's record, the user inputs the employee's name. When the employee is found, the last known (current) team tree structure is shown. The tree can show the employee's management chain, their colleague connections, team name, role and responsibilities, and as the time changes as well as other features to show relationships.

It is noted the user 54 might be required to authenticate thru the use of passwords or other security protocols to access the web server 56. The web server 56, in this case, is used to deliver web pages on the request to clients using the Hypertext Transfer Protocol (HTTP) as well as send requests by the user to search for an employee relationship criteria. The web server 56 posts the search request to the application server 58 to be analyzed by the by the MVC framework 36, which reviews the content of the message to determine if application data is needed and formulates SQL statements to retrieve data associated with the search request. The application server 58 sends the SQL statements to the SQL server 60 via JDBC calls. The SQL server 60 parses the SQL statements for errors.

Moreover, the SQL server 60 then performs the SQL operations on each of the databases associated with the SQL server 60 by selecting records from various tables and performing joining operations to get results. In FIG. 3A, the user 54 requested a search regarding all employees holding a role while FIG. 3B the user 54 requested a search regarding all information associated with an employee. The process flow for both requests are the same. The retrieved data is sent back to the application server 58. The application server 58 using the MVC framework prepares the actual presentation of data to be sent back to the web server 56 illustrating the employee's relationship with the enterprise described in FIG. 1.

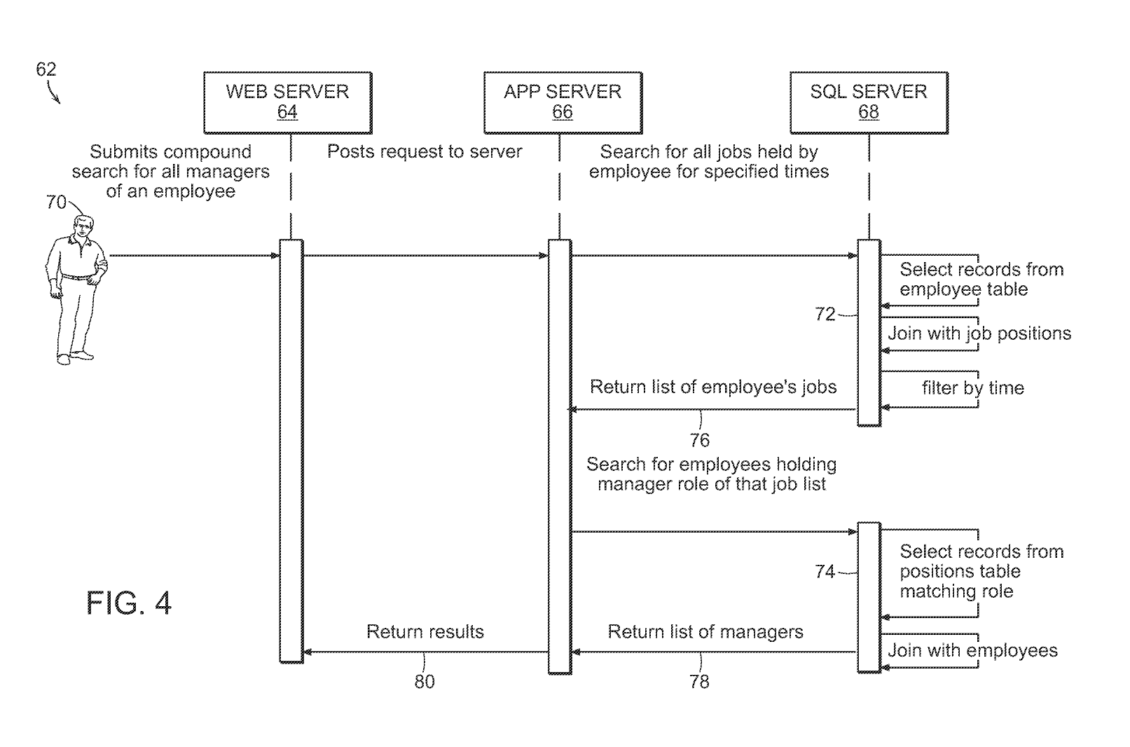

FIG. 4 is a schematic diagram illustrating the process flow 62 for performing compound searches. A user 70 issues a search request through a web browser involving a compound search for all managers for an employee. The web server 64 receives the search request processes the search request to be posted to the application server 66. The application server 66 analyzes the content of the request and determines if it requires application data, and if not the message is parsed to implement SQL statements needed to query the SQL server's 68 databases. Using the MVC framework, the application server 66 formulates SQL statements that are broken into several different queries and then executed separately by the SQL server 68 to retrieve data from the SQL server's databases. This results in multiple queries 72, 74 being executed by the SQL server 68. The application server 66 controls the flow of the multiple queries associated with compound statements. The application server 66 can utilize the MVC framework to format the results 76, 78 of the compound searches into a style preferred by the user 70. The application server 66 sends the results 80 to the web server 64 for presentation to the user 70.

The present invention is platform independent and can execute in any browser such as Firefox®, Internet Explorer®, or Chrome®. The application used by the invention can also be written in any platform independent-based computer language, such as Java or the like. The invention can be executed on a client computer or server using a processor or the like. All application code used by the invention can be stored in the RAM or ROM of the client or server. Furthermore, the application code can be stored on an external memory device to be uploaded to the client computer for execution. The other elements used by the invention can be executed from a client computer or on a remote server, and can also be written in any platform independent-based computer language, such as Java or the like. The servers described herein can be local on the client computer or on a remote server. The client computer, remote server, and database servers communicate to each other using known communication protocols, such as TCP/IP.

Although the present invention has been shown and described with respect to several preferred embodiments thereof, various changes, omissions and additions to the form and detail thereof, may be made therein, without departing from the spirit and scope of the invention.

What is claimed is:

1. An enterprise-based tree structure system comprising:
a plurality of servers for receiving and processing a request for retrieval of enterprise-based information of an employee, the enterprise-based information includes information detailing the employee's contacts and affiliation within an enterprise, the enterprise-based information is stored in one or more of the servers; and
a framework that aids the servers to process and retrieve the enterprise-based information stored in the one or more servers needed to service the request, the framework processes the enterprise-based information allowing a user the ability to understand and identify the employee's contact and affiliation with the enterprise, once the one or more servers retrieve the enterprise-based information that resembles a tree-structure illustrating an employee's employment relationships, the framework processes the tree-structure and develops a user interface to graphically illustrate the particular details of an employee's employment relationship to a user, the framework manages the required processing needed to retrieve the employee's employment relationships by coordinating one or more database statements to retrieve the employee's information across one or more databases.

2. The enterprise-base tree structure system of claim 1, wherein the servers comprise at least one web server, application server, and SQL server.

3. The enterprise-base tree structure system of claim 1, wherein the web server receives the request for retrieval of the enterprise-based information of the employee and issues the request to the application server.

4. The enterprise-base tree structure system of claim 3, wherein the application server comprises the framework that communicates with the SQL server to retrieve the enterprise-based information of the employee.

5. The enterprise-base tree structure system of claim 4, wherein the framework formulates the presentation of the retrieved enterprise-based information to the web server for viewing by a user.

6. The enterprise-base tree structure system of claim 1, wherein the enterprise-based information comprises information that details an employee's employment relationship within the enterprise.

7. The enterprise-base tree structure system of claim 6, wherein the enterprise-based information comprise information regarding the employee's managers and roles throughout the time the employee is working in the enterprise.

8. The enterprise-base tree structure system of claim 6, wherein the enterprise-based information is displayed in a format illustrating an employee's employment relationship with the enterprise over time.

9. A method of managing an enterprise-based tree structure system comprising:
receiving and processing a request for retrieval of enterprise-based information of an employee from a plurality of servers, the enterprise-based information includes information detailing the employee's contacts and affiliation within an enterprise, the enterprise-based information is stored in one or more of the servers; and
processing and retrieving the enterprise-based information stored in the one or more servers needed to service the request using a framework, the framework processes the enterprise-based information allowing a user the ability to understand and identify the employee's contact and affiliation with the enterprise, once the one or more servers retrieve the enterprise-based information that resembles a tree-structure illustrating an employee's employment relationships, the framework processes the tree-structure and develops a user interface to graphically illustrate the particular details of an employee's employment relationship to a user, the framework manages the required processing needed to retrieve the employee's employment relationships by coordinating one or more database statements to retrieve the employee's information across one or more databases.

10. The enterprise-base tree structure system of claim 9, wherein the servers comprise at least one web server, application server, and SQL server.

11. The enterprise-base tree structure system of claim 9, wherein the web server receives the request for retrieval of the enterprise-based information of the employee and issues the request to the application server.

12. The enterprise-base tree structure system of claim 11, wherein the application server comprises the framework that communicates with the SQL server to retrieve the enterprise-based information of the employee.

13. The enterprise-base tree structure system of claim 12, wherein the framework formulates the presentation of the retrieved enterprise-based information to the web server for viewing by a user.

14. The enterprise-base tree structure system of claim 9, wherein the enterprise-based information comprises information that details an employee's employment relationship within the enterprise.

15. The enterprise-base tree structure system of claim 14, wherein the enterprise-based information comprise information regarding the employee's managers and roles throughout the time the employee is working in the enterprise.

16. The enterprise-base tree structure system of claim 14, wherein the enterprise-based information is displayed in a format illustrating an employee's employment relationship with the enterprise over time.
